(19) United States
(12) Patent Application Publication
(10) Pub. No.: US 2025/0259440 A1
(43) Pub. Date: Aug. 14, 2025

(54) AUTOMATED ELEVATION ADJUSTMENTS USING OBJECT IDENTIFICATION ON AERIAL IMAGES

(71) Applicant: AI CLEARING INC., Austin, TX (US)

(72) Inventors: Michal MAZUR, Warsaw (PL); Adam WISNIEWSKI, Warsaw (PL); Jakub LUKASZEWICZ, Warsaw (PL); Dariusz CIESLA, Warsaw (PL)

(21) Appl. No.: 18/866,998

(22) PCT Filed: May 19, 2023
(86) PCT No.: PCT/IB2023/055186

§ 371 Date: Nov. 18, 2024

(30) Foreign Application Priority Data
May 19, 2022 (EP) 22174343.8

(51) Int. Cl. G06V 20/17; G06V 10/764; G06V 10/82

(52) U.S. Cl. CPC G06V 20/17; G06V 10/764; G06V 10/82

(57) ABSTRACT

Disclosed is a system and method configured for identifying object(s), comprising at least one data processing component configured to process at least one input to generate image data. Further comprising at least one object identifying component configured to automatically generate at least one class based on the image data. Furthermore, comprising at least one analysing component configured to automatically modify the at least one portion of the object from the processed input based on the class.

The present invention relates to the field of image analysis and particularly to the field of analysis of aerial images. The present invention further relates to identifying objects in aerial imagery.

Automatic identification of objects such as buildings or roads from digital aerial imagery is generally known. The automated identification of the objects can be best used in the field of construction, wherein the change is fast and often unpredictable. An important aspect of any construction site is to track the progress of the construction in real time. Currently this is labour-intensive processes prone to error or manipulation.

One solution to this problem can be the calculations of volumes of earth, gravel or any other materials changed on the construction site. The volumes are commonly calculated using digital surface models. These models however are prone to errors because they may include artificial objects that do not add any meaning to such calculations, for example, a truck parked at the construction site.

U.S. Pat. No. 10,339,663 B2 discloses systems and methods for generating georeferenced information with respect to aerial images. In particular, in one or more embodiments, systems and methods generate georeference information relating to aerial images captured without ground control points based on existing aerial images. For example, systems and methods can access a new set of aerial images without ground control points and utilize existing aerial images containing ground control points to generate a georeferenced representation corresponding to the features of the new set of aerial images. Similarly, systems and methods can access a new image without ground control points and utilize an existing georeferenced orthomap to produce a georeferenced orthomap corresponding to the features of the new image. One or more embodiments of the disclosed systems and methods permit users to obtain georeference information related to new images without the need to place ground control points or collect additional georeferenced information.

U.S. Pat. No. 10,593,108 B2 discloses systems and methods for more efficiently and quickly utilizing digital aerial images to generate models of a site. In particular, in one or more embodiments, the disclosed systems and methods capture a plurality of digital aerial images of a site. Moreover, the disclosed systems and methods can cluster the plurality of digital aerial images based on a variety of factors, such as visual contents, capture position, or capture time of the digital aerial images. Moreover, the disclosed systems and methods can analyse the clusters independently (i.e., in parallel) to generate cluster models. Further, the disclosed systems and methods can merge the cluster models to generate a model of the site.

U.S. Pat. No. 9,389,084 B2 is directed toward systems and methods for identifying changes to a target site based on aerial images of the target site. For example, systems and methods described herein generate representations of the target site based on aerial photographs provided by an unmanned aerial vehicle. In one or more embodiments, systems and method described herein identify differences between the generated representations in order to detect changes that have occurred at the target site.

An important part of the construction is progress tracking and quantitative measurement of progress. Currently, the above are manual, labour-intensive processes prone to error or manipulation. One of the most important areas of calculations are volumes of earth, gravel or any other materials moved on the construction site. The volumes are commonly calculated using drone images generated DSM (digital surface models) or DEM (digital elevation models).

DSM/DEMs however, are prone to errors because they may include 3D coordinates of artificial objects that should not be taken into account (like machines parked or moving on the gravel surface). These objects should be removed and Z coordinates of surrounding DSM should be taken into account.

### SUMMARY

It is therefore an object of the invention to overcome or at least alleviate the shortcomings and disadvantages of the prior art. More particularly, it is an object of the present invention to provide an improved method, system and computer program product for controlling of constructional sites and/or analysis of aerial images.

The core of the invention is to use automated objects identification provided by machine learning solutions to enable automatic removal volumes not to be included (cars, tracks, storage areas) from volumetric earthworks calculations, based on AI classification results. The goal of the disclosure is to enable identification of the objects to be removed from DSM/DEMs and deduct their volumes form volumetric calculations. For example, an embankment of 100 cubic meters is to be built in an area, however, the volume calculation result is 105 m3. This volume can be measure by methods as described below. For example, the extra 5 m3 in volume calculations is because of a heavy equipment parked on the embankment. The goal of the invention is to automatically identify the parked object and then adjust the calculations.

The term “volume” is intended to refer to a solid, i.e. to a three-dimensional body, in other words a shape. A volume corresponding to an object may be a volume approximating a geometry of the object. In case that the object is an excavation, depression, hole or the like, the volume may thus also be a shape between a surface of the object and the former surface, e.g. a ground surface.

The term “reference surface” of an object is intended to refer to a surface limiting the volume corresponding to the object wherein the surface is not directly present in a DEM, such as a lower surface of an object places on the ground, e.g. a heap, construction material or a vehicle. Another example for such a surface that is not directly present in said DEM may be a former ground surface of the excavation, depression, hole or the like, as discussed above.

Whenever x-, y- and/or z-coordinates or directions are used within this disclosure, the z-direction may be vertical, in other words orthogonal to a ground surface. The x- and y-directions may be orthogonal to each other and to the z-direction, i.e. they may be horizontal directions. The coordinates may form a Cartesian coordinate system. Further, the coordinates may also form geographic and/or geodetic coordinate systems based on sphere or ellipsoid.

The orthophoto map may also be referred to as orthomosaic or orthophoto. The orthophoto map may be generated based on at least one plurality of aerial images by means of photogrammetry. In other words, the orthophoto map may be generated by orthorectifying the one or more aerial images.

The digital elevation model (DEM) may be at least one of a digital surface model (DSM) and a digital terrain model (DTM).

In this disclosure, the term “polygon” is intended to refer to a geometric shape comprising n vertexes and n edges wherein the edges only intersect at the vertexes.

The person skilled in the art will easily understand that the polygon(s) which each approximate a part of the input orthophoto map (O) may in other words be linear ring(s) or closed polygonal chain(s), and that the polygon(s) may be indicated for example by one or more triangles forming a polygon. Thus, the polygon(s) may for example be described as at least one or a plurality of neighbouring triangles per polygon.

The term “object” is intended to refer to an object in the area. However, “object” may refer only to objects of interest, i.e., objects that are to be detected. For example, plain ground may not need to be detected or further classified. Objects that are no objects of interest may however be detected, e.g., as “background”.

The objects may correspond to parts. The term “part” may to refer to a part of the area corresponding to an object or a portion thereof, e.g., when only a portion of an object is within the area, or when only a section of the area is processed or photographed, which section only comprises a portion of an object. The term “part” may also refer to a portion of an orthophoto map or a digital elevation model, which portion corresponds to an object in the area.

In a first embodiment, a system is disclosed. The system is configured for identifying object(s), wherein the system comprising at least one data processing component configured to process at least one input to generate image data. The system comprising at least one object identifying component configured to automatically generate at least one class based on the image data. The system comprising at least one analysing component configured to automatically modify the at least one portion of the object from the processed input based on the class.

In some embodiments the data processing component can be configured to process the input, wherein the input can be at least one digital elevation model (DEM) of an area.

In some embodiments the data processing component is configured to process the input, wherein the input can comprise at least one orthophoto map of an area.

In some embodiments the input may comprise RGB data. In the present disclosure, the term “RGB data” is intended to refer to data relating to colours in a human-visible spectrum. However, different representations of colour data, i.e., relating to a wavelength of light in the visible spectrum, are intended to be encompassed by the term “RGB data”, too.

In some embodiments the object identifying component may be configured to generate the class of the object using the image data.

In some embodiments the object and/or at least a portion of the object may comprise at least one element of the input and/or the image data.

In some embodiments the analysing component may be configured to identify the at least one object from the image data based on the class. In such embodiments the analysing component may also be configured to automatically detect a relevancy of the identified object.

In some embodiments the object identifying component can comprise at least machine learning framework, such as neural networks.

In some embodiments the machine learning framework can comprise recurrent neural network and/or convolution neural network and/or generative adversarial network.

In some embodiments the object identifying component may be configured to be trained on an image object. The image object may be pre-determined object. The image object may be a part of the input, for example, on a construction site there might be a car parked. In such embodiments the object identifying component may be trained on ‘vehicle data’ to automatically identify the car (image object).

In some embodiments the object identifying component may be configured to identify the image object. The image object may comprise characteristic property of the object as a function of the object.

In some embodiments the image object comprises modelling of material properties of the object. This can be advantageous when different kinds of sensors are used, like optical, LIDAR and radar.

In some embodiments the image object can comprise geometric and/or topologic regularities of the object. For buildings they are especially suited for simple types, e.g., with perpendicular outlines and flat roofs, and the construction of hypotheses for more complex buildings.

In some embodiments the image object can comprise levels of abstraction and scale of the object and/or geometric and/or topological neighbourhood of the object.

In some embodiments the object identifying component may comprise an image classifier. The image classifier may be configured to categorise and label groups of pixels or vectors within the image data on pre-determined rules. In such embodiments the rules can be automatically defined by the object identifying component, based on at least one past unsupervised training.

In some embodiments the object identifying component can be configured to determine the class based on the image object.

In some embodiments the object identifying component may be configured to generate at least one or a plurality of polygon(s) based on the input, each polygon approximating a part of the input.

In some embodiments the object identifying component may be configured to project the polygon(s) on the at least one digital elevation model and/or the input and/or the image data.

In some embodiments the object identifying component may be configured to process elevation coordinates of the vertexes of the at least some polygon(s) projected to the input and/or digital elevation model and/or image data.

In some embodiments the object identifying component may be configured to communicate the class to the analysing component.

In some embodiments the analysing component may be configured to modify the at least elevation coordinate of the at least one of the DEM and/or the input. In such embodiments the modified elevation coordinates might be corresponding to the projected polygon.

The input and/or the DEM might comprise a single channel (monochromatic) raster (matrix) in which the position of at least one pixel (x,y,) may correspond to coordinates of the pixel corresponding to the at least one elevation coordinates. The analysing component may modify/change the at least one elevation coordinate in the raster of the DEM (digital elevation model).

The analysing component may modify the at least one elevation corresponding to the DEM which may be based on the projected polygon(s).

The analysing component may modify the at least one elevation corresponding to the DEM.

In some embodiments the analysing component may be configured to generate a reference surface for each of at least some of the polygons.

In some embodiments the analysing component may be configured for determining a volume between a portion of the input and a portion of the reference surface for each reference surface.

In some embodiments the analysing component may be configured to determine the volume between the portion of the input and the portion of the reference surface for each reference surface.

In some embodiments the portion of the reference surface may comprise a portion of the reference surface within the corresponding polygon and the portion of the input is a portion of the input within said polygon.

In some embodiments the term modify can comprises adjusting the at least one elevation coordinate corresponding to the image object based on the reference surface.

In some embodiments the class can corresponds to a part of the input.

In some embodiments the class can comprise at least a portion of the object.

In some embodiments the class can comprise a plurality of the objects.

In some embodiments the analysing component can be configured to assigning portions of the input comprising same class to a group.

In some embodiments the analysing component can be further configured to modify the at least a portion of the group from the processed input.

In a second embodiment a method is disclosed. The method is configured to be performed on the system as described.

In a third embodiment, a computer program product is disclosed.

A computer program product may comprise instructions which, when the program is executed by a computer, cause the computer to carry out the steps of the above-disclosed method.

Another computer program product may comprise instructions which, when the program is executed by a data processing component, cause the data processing component to carry out the steps for which the data-processing system is configured.

The following embodiments also form part of the invention.

### System Embodiments

Below, embodiments of a system will be discussed. The system embodiments are abbreviated by the letter “S” followed by a number. Whenever reference is herein made to the “system embodiments”, these embodiments are meant.

S1. A system for identifying object(s), wherein the system comprising:
at least one data processing component configured to process at least one input to generate image data,
at least one object identifying component configured to automatically generate at least one class based on the image data.
at least one analysing component configured to automatically modify the at least one portion of the object from the processed input based on the class.
   S2. The system according to the preceding embodiment wherein the data processing component is configured to process the input, wherein the input is at least one digital elevation model (DEM) of an area.
   S3. The system according to the preceding embodiment wherein the data processing component is configured to process the input, wherein the input comprises at least one orthophoto map of an area.
   S4. The system according to any of the preceding embodiments wherein the object identifying component is configured to generate the class of the object using the image data.
   S5. The system according to any of the preceding embodiments wherein the object and/or at least a portion of the object comprises at least one element of the input.
   S6. The system according to any of the preceding embodiments wherein the analysing component is configured to identify the at least one object from the image data based on the class.
   S7. The system according to any of the preceding embodiments wherein the object identifying component comprises at least machine learning framework, such as neural networks.
   S8. The system according to any of the preceding embodiments wherein the machine learning framework comprises recurrent neural network and/or convolution neural network.
   S9. The system according to any of the preceding embodiments wherein the machine learning framework comprises generative adversarial network.
   S10. The system according to any of the preceding embodiments wherein the object identifying component is further configured to be trained on an image object.
   S11. The system according to any of the preceding embodiments wherein the object identifying component is configured to identify the image object.
   S12. The system according to any of the preceding embodiments wherein the image object comprises characteristic property of the object as a function of the object.
   S13. The system according to any of the preceding embodiments and features of S10 wherein the image object comprises modelling of material properties of the object.
   S14. The system according to any of the preceding embodiments and features of S10 wherein the image object comprises geometric and/or topologic regularities of the object.
   S15. The system according to any of the preceding embodiments and features of S10 wherein the image object comprises an image model of the object.
   S16. The system according to any of the preceding embodiments and features of S10 wherein the image object comprises levels of abstraction and scale of the object.
   S17. The system according to any of the preceding embodiments and features of S10 wherein the image object comprises geometric and/or topological neighbourhood of the object.
   S18. The system according to any of the preceding embodiments wherein the object identifying component is further configured with an image classifier.
   S19. The system according to any of the preceding embodiments wherein the object identifying component is configured to determine the class based on the image object.
   S20. The system according to any of the preceding embodiments wherein the object identifying component is configured to generate at least one or a plurality of polygon(s) based on the input, each polygon approximating a part of the input.
   S21. The system according to any of the preceding embodiments wherein the object identifying component is configured to project the polygon(s) on the at least one digital elevation model.
   S22. The system according to any of the preceding embodiments wherein the object identifying component is configured to project the polygon(s) on the at least one input.
   S23. The system according to the preceding embodiment wherein the object identifying component is configured to process elevation coordinates of the vertexes of the at least some polygon(s) projected to the input and/or image data.
   S24. The system according to any of the preceding embodiments wherein the object identifying component is configured to communicate the class to the analysing component.
   S25. The system according to any of the preceding embodiments wherein the analysing component is configured to modify the at least elevation coordinate of the at least one of the at least one input and/or the DEM.
   S26. The system according to any of the preceding embodiments wherein the analysing component is configured to generate a reference surface for each of at least some of the polygons.
   S27. The system according to any of the preceding embodiments wherein the analysing component is configured for determining a volume between a portion of the input and a portion of the reference surface for each reference surface.
   S28. The system according to the preceding embodiment wherein the analysing component is configured for determining the volume between the portion of the input and the portion of the reference surface for each reference surface.
   S29. The system according to any of the two preceding embodiments wherein the portion of the reference surface is a portion of the reference surface within the corresponding polygon and the portion of the input is a portion of the input within said polygon.
   S30. The system according to any of the preceding embodiments wherein modify comprises modifying the at least one elevation coordinate corresponding to the image object based on the reference surface.
   S31. The system according to the preceding embodiment and features of S23 wherein the image object comprises at least one matrix in which position of at least on pixel corresponds to coordinates of the pixel corresponds to elevation coordinates.
   S32. The system according to any of the preceding embodiments wherein the class corresponds to a part of the input.
   S33. The system according to any of the preceding embodiments wherein the class comprises at least a portion of the object.
   S34. The system according to any of the preceding embodiments wherein the class comprises a plurality of the objects.
   S35. The system according to any of the preceding embodiments wherein the analysing component is configured to assigning portions of the input comprising same class to a group.
   S36. The system according to any of the preceding embodiments wherein the analysing component is further configured to modify the at least a portion of the group from the processed input.

### Method Embodiments

Below, embodiments of a method will be discussed. The method embodiments are abbreviated by the letter “M” followed by a number. Whenever reference is herein made to the “method embodiments”, these embodiments are meant.

M1. A method, comprising:
processing at least one input by a data processing component to generate image data,
automatically generating at least one class using the object identifying component,
automatically modifying at least one portion of the image data based on the class.
   M2. The method according to the preceding embodiment comprising providing input, wherein the input comprises digital elevation model (DEM).
   M3. The method according to any of the preceding embodiments comprising providing input, wherein the input comprises orthophoto map of an area.
   M4. The method according to any of the preceding embodiments comprising generating the class of the object using the image data.
   M5. The method according to any of the preceding embodiments wherein an object and/or at least a portion of an object comprises at least one element of the input.
   M6. The method according to any of the preceding embodiments comprising eliminating the at least one object from image data based on the class.
   M7. The method according to any of the preceding embodiments comprising providing the object identifying component with at least one machine learning framework, such as neural networks.
   M8. The method according to any of the preceding embodiments comprising providing the machine learning framework with recurrent neural network and/or convolution neural network.
   M9. The method according to any of the preceding embodiments comprising providing the machine learning framework with generative adversarial network.
   M10. The method according to any of the preceding embodiments comprising training the object identifying object.
   S37. The system according to any of the preceding system embodiments configured to carry out any of the method steps according to any of the preceding method embodiments.

### Computer Program Product Embodiments

Below, embodiments of a computer program product will be discussed. These embodiments are abbreviated by the letter “C” followed by a number. Whenever reference is herein made to the “computer program product embodiments”, these embodiments are meant.

C1. A computer program product comprising instructions which, when the program is executed by a computer, cause the computer to carry out the steps of the method according to any of the method embodiments.
C2. A computer program product comprising instructions which, when the program is executed by a data processing component, cause the data processing component to perform the operations for which the data processing component is configured.

Exemplary features of the invention are further detailed in the figures and the below description of the figures.

### BRIEF DESCRIPTION OF THE FIGURES

FIG. 1 shows depicts an embodiment according to the present invention.

FIG. 2 shows an exemplary embodiment of the present invention.

FIG. 3 shows an exemplary embodiment according to the present invention.

FIG. 1 depicts a system 1 comprising a data processing component 10 and a sensor 2. The data processing component 10 is configured to accept an input 3 from the sensor 2, and based thereon, to generate an input 20 of an area. The sensor 2 may be configured to monitor the area and capture data relating to the area. The data captured by the sensor 2 may be sent to the data processing component 10. The sensor 2 may comprise a photon sensor configured to detect photons incident on a screen of the sensor 2. The sensor 2 may comprise a lidar sensor, or a radar sensor, that may be of advantage in determining a distance to a reflecting surface of the area. The input 20 may comprise an aerial image of the area.

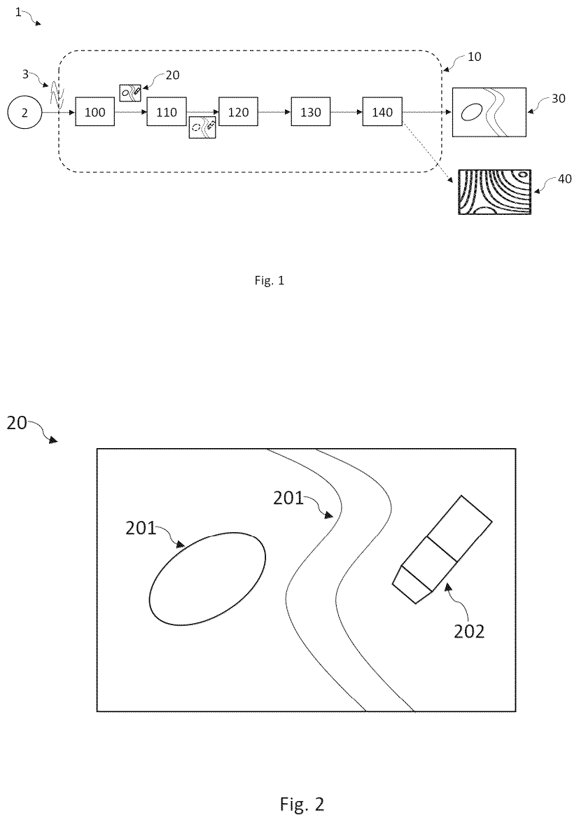

An exemplary input 20 is depicted in FIG. 2. The area may comprise a construction site, for example. The data processing component 10 may be configured to process the input 20 and generate image data 30. The image data 30 may also comprise an image of the area. The image data 30 may be based on the input 20. The data processing component 10 may be further configured to generate a processed digital elevation model 40 (DEM) of the area. The system 1, may be configured for modifying an object 202 from the input 20 to generate the image data 30 and/or the processed DEM 40. Further details of this process are described below.

The data processing component 10 may comprise one or more processing units configured to carry out computer instructions of a program (i.e. machine readable and executable instructions). The processing unit(s) may be singular or plural. For example, the data processing component 10 may comprise at least one of CPU, GPU, DSP, APU, ASIC, ASIP or FPGA.

The data processing component 10 may comprise memory components, such as the data storage component. The data storage component as well as the data processing component 10 may comprise at least one of main memory (e.g. RAM), cache memory (e.g. SRAM) and/or secondary memory (e.g. HDD, SDD).

The data processing component 10 may comprise volatile and/or non-volatile memory such an SDRAM, DRAM, SRAM, Flash Memory, MRAM, F-RAM, or P-RAM. The data processing component 10 may comprise internal communication interfaces (e.g. busses) configured to facilitate electronic data exchange between components of the data processing component 10, such as, the communication between the memory components and the processing components.

The data processing component 10 may comprise external communication interfaces configured to facilitate electronic data exchange between the data processing component 10 and devices or networks external to the data processing component 10, e.g., for receiving data from the unmanned aerial vehicle.

For example, the data processing component 10 may comprise network interface card(s) that may be configured to connect the data processing component 10 to a network, such as, to the Internet. The data processing component 10 may be configured to transfer electronic data using a standardized communication protocol. The data processing component 10 may be a centralized or distributed computing system.

The data processing component 10 may comprise user interfaces, such as an output user interface and/or an input user interface. For example, the output user interface may comprise screens and/or monitors configured to display visual data (e.g. an orthophoto map (O) of the area 10) or speakers configured to communicate audio data (e.g. playing audio data to the user). The input user interface may e.g. a keyboard configured to allow the insertion of text and/or other keyboard commands (e.g. allowing the user to enter instructions to the unmanned aerial vehicle or parameters for the method) and/or a trackpad, mouse, touchscreen and/or joystick, e.g. configured for navigating the orthophoto map O or objects identified in the orthophoto map.

To put it simply, the data processing component 10 may be a processing unit configured to carry out instructions of a program. The data processing component 10 may be a system-on-chip comprising processing units, memory components and busses. The data processing component 10 may be a personal computer, a laptop, a pocket computer, a smartphone, a tablet computer.

The data processing component 10 may comprise a server, a server system, a portion of a cloud computing system or a system emulating a server, such as a server system with an appropriate software for running a virtual machine. The data processing component 10 may be a processing unit or a system-on-chip that may be interfaced with a personal computer, a laptop, a pocket computer, a smartphone, a tablet computer and/or user interfaces (such as the upper-mentioned user interfaces).

The data-processing component comprises a portion located in a cloud system. This may be optionally advantageous, as training and evaluating a neural network may be particularly demanding in terms of computing power. This computing power may be provided efficiently by means of a cloud-computing system.

The data processing component 10 may comprise an image generating component 100 configured to generate the input 20 of the area based on data received from the sensor 2. Generating the input 20 may comprise ortho-rectifying the data received from the sensor 2 for correcting for geometric distortions, for example. The data processing component 10, particularly the image generating component 100 thereof, may be further configured for assigning a position to a pixel in the image 20, wherein the position corresponds to a position of the location corresponding to the pixel in the image 20. The position may be assigned with respect to a defined origin and co-ordinate system. The position may comprise, for example, a latitude and a longitude corresponding to the location of the at least one pixel depicted in the image. The position may be assigned by means of data received by the data processing component 10 from a satellite, or from a ground-based network. The position may be determined by means of photogrammetry (e.g., Real-Time Kinematic photogrammetry).

The data processing component 10, particularly the image generation component 100 thereof, may be configured to also determine an elevation of the location corresponding to at least one pixel depicted in the image. Thus, the data processing component 10 may be configured to determine the elevation as well as the latitude and the longitude corresponding to the location of at least one pixel depicted in the image. The data processing component 10 may further determine any of the elevation or the position of a plurality of pixels in the image.

The elevation information may be used to generate the DEM of the area depicted in the input 20. The DEM may comprise the elevation of the location corresponding to a pixel in the input 20. Preferably, the DEM may comprise the elevation of a plurality of locations each corresponding to a pixel in the image 20. The data processing component 10 may be configured to generate the DEM based on data acquired by the sensor 2. In particular, data from a lidar or radar sensor, as described above, may be of particular advantage in generating the DEM.

The data processing component 10 may comprise an object identifying component 110, configured to identify an image object 201 in the input 20. An exemplary input 20 comprising an exemplary image object 201 is depicted in FIG. 2. FIG. 2 further depicts an identified image object 202 that is to be removed from the input 20 to generate the image data 30 and/or the DEM 40 as described above. An image object 201 or 202 may be understood to comprise an object identified in the input 20 that corresponds to a real-world object. The object may comprise any of, for example, a person, a protective equipment, or a crack in the surface. Identification of the image object 201 may comprise, for example, determining a rectangular region of the input 20 (identified by means of the pixels at the 4 corners, for example) that corresponds to the identified image object 201. In the following, an exemplary embodiment of the method is described with reference to the image object 201. However, it may be understood that a similar method may be applied with reference to the identified image object 202. In particular, the image objects 201 and 202 may be considered equivalent for at least one step of the method as described herein.

The object identifying component 110 may identify the image object 201 by means of a suitable image processing algorithm such as edge detection, or an artificial-intelligence based algorithm. Preferably, the object identifying component 110 may identify the image object 201 by means of a trained neural network. The trained neural network may comprise a trained convolutional neural network. The neural network may be trained on images of the area with, for example, regions of the image marked out as image objects. This may comprise, for example, labelling pixels in the image corresponding to image objects with an identifier.

The data processing component 10 may be configured to send the image data 30 to the object identifying component 110. An output of the object identifying component 110 may comprise (optionally) an orthophoto map and/or DEM 20 and at least one or a plurality of image objects 201 identified in the input 20. The object identifying component 110 can comprise an image classifier 120, configured to assign, from a list of classes, a class to the image object 201. The list of classes may comprise, for example, background (i.e., no object of interest), asphalt, concrete foundation, concrete ring, pipe, tree, black or dark sand, cable well, cars, chipping, container, crack, dump truck, heap of earth, heap of sand, heavy earth equipment, lantern, people, reinforcement, rubble, scaffolding, silo, water, wooden boards, fence, pavement, crushed stone for railways (e.g., for track ballast), concrete grid, paving blocks, aggregate (e.g., for generation of electricity or compressed air), geotextile, sheet piling (such as Larsen sheet piling), artificial rocks, formwork, retaining wall, crane, steel structure, wall, roof, protective equipment, or floor.

The person skilled in the art will easily understand that, instead of assigning the class “background” to a portion, the method may also comprise not assigning a class to said portion or assigning a “null”-class to a portion. It may also be appreciated that the above list is to be considered an exemplary, but not limiting, list of classes that may be used to classify the image object 201.

The classification may be achieved by means of a trained neural network, preferably a trained convolutional neural network. The trained neural network used for classification may or may not be the same as the trained neural network used for segmentation.

The data processing component 10 may further comprise an analysing component 130. The analysing component 130 may be configured to determine, for each of the image objects 201, whether or not the image object 201 is to be modified/adjusted/removed. This may be based, for example, on a class of the image object 201. For example, an image object 201 may be classified as a “car”. In this case, the image object “car” may be relevant in the input 20, as such an image object (that may now be identified with the image object 202) may not correspond to an object of interest when assessing, for example, progress at the construction site. Alternatively, an image object 201 may be classified as “concrete grid” which may be of importance in assessing progress at the construction site and so may not be edited in the input 20. Modifying the image object 202 here may comprise removing the image object 202 and generating the image data 30 and/or the processed DEM 40, wherein the processed image 30 corresponds to an image of the construction site, for example, after construction work at the site is complete. Generally, it may be understood to comprise removal of image objects corresponding to any non-permanent objects from the image 20.

Determination of modifiable image objects 202, as carried out by the analysing component 130, may also be based on design data of the area. For example, image objects 201 corresponding to objects not disclosed in the design data of the area may be marked as removable/modifiable. Thus, the analysing component 130 may be configured to also accept design data of the area, and compare the input 20 of the area to the design data.

An output of the analysing component 130 may comprise the image data 30, with image objects 201, some of which may be determined to be adjusted and marked as such. Note that the analysing component 130 may not identify any image objects 201 as not relevant. However, when there is at least one relevant image object 201, the data processing component 10 may be configured to send the input 20 with the image objects 201 and 202 to the analysing component 140.

The analysing component 140 may be configured to adjust the relevant image object 202 from the input 20 and generate the image data 30 and/or the processed DEM 40. Adjusting the relevant image object 202 from the image 20 may comprise determining, for example, an area on the image corresponding to the relevant image object 202. Adjusting the image object 202 from the DEM, generated as described above, may comprise determining, for example, the elevation of at least one, preferably a plurality of, pixel(s) comprised in the image object 202.

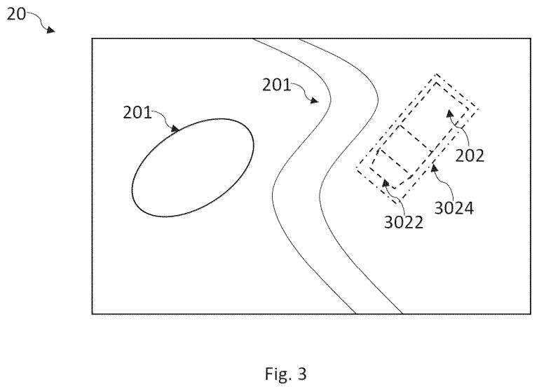

FIG. 3 depicts an exemplary embodiment of adjusting the relevant image object 202. Adjusting the relevant image object 202 may comprise, for example, generating an object polygon 3022 (dashed) to approximate the relevant image object 202. The object polygon 3022 may then be projected on to the DEM of the area, generated as described above. Further, based on the object polygon 3022 generated to approximate, for example, a boundary of the relevant image object 202, a reference polygon 3024 (dashed-dotted) may be generated that may enclose the object polygon 3022. The object polygon 3022 corresponding to the relevant image object 202 is enclosed by the reference polygon 3024. Preferably, the reference polygon 3024 comprises the object polygon 3022. The reference polygon 3024 may be of advantage in determining a reference surface for the removable image object 202.

The analysing component 140 may be configured to further generate a reference surface for the relevant image object 202 based on the reference polygon 3024. The reference surface may be generated by choosing a plurality of representative vertices on the reference polygon 3024. The elevation of locations corresponding to each of the plurality of representative vertices may be determined, from the DEM, for example. The elevation of each of the representative vertices may then be used to generate the reference surface. For example, the reference surface may comprise a surface passing through each of the representative vertices. Alternatively, a statistical measure of the elevation of each of the representative vertices may be determined and the reference surface may comprise a horizontal surface of elevation significantly identical to the statistical measure.

Once the reference surface has been generated, the analysing component 140 may be configured to remove the relevant image object 202 by replacing the object 202 by a section of the reference surface, for example. In embodiments, other methods may be used to adjust the relevant image object 202, comprising, for example, interpolation of the reference surface. Replacement by a section of the reference surface may comprise setting values corresponding to each of the pixels comprised in the image object 202 to values corresponding to the reference surface. For example, the elevation corresponding to each of the pixels comprised in the image object 202 may be replaced by an elevation related to the elevation of the reference surface.

As may be appreciated, a general approach for adjusting the relevant image object 202 may comprise obtaining a mathematical relation between the value of a quantity, for the reference surface, at different locations. The quantity may comprise, for example, elevation, or an RGB value for the apparent colour of the reference surface. The mathematical relation may then be extended to the region corresponding to the relevant image object 202 by a suitable procedure.

The analysing component 140 may be further configured to generate the image data 30 and/or the processed DEM 40 after adjusting the relevant image object 202 as described above.

While in the above, a preferred embodiment has been described with reference to the accompanying drawings, the skilled person will understand that this embodiment was provided for illustrative purpose only and should by no means be construed to limit the scope of the present invention, which is defined by the claims.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one

1-15. (canceled)

16. A system for identifying object(s), wherein the system comprising:
at least one data processing component configured to process at least one input to generate image data,
at least one object identifying component configured to automatically generate at least one class based on the image data,
at least one analysing component configured to automatically modify the at least one portion of the object from the processed input based on the class.

17. The system according to claim 16 wherein the input comprises at least one digital elevation model (DEM) of an area and/or at least one orthophoto map of an area.

18. The system according to claim 16 wherein the object identifying component comprises at least machine learning framework, such as neural networks, preferably convolutional neural network and/or generative adversarial network.

19. The system according to claim 16 wherein the object identifying component is further configured to be trained on an image object to identify at least one image object.

20. The system according to claim 19 wherein the image object comprises at least one of geometric and/or topologic regularities of the object and at least abstraction and scale of the object and at least geometric and/or topological neighbourhood of the object.

21. The system according to claim 16 wherein the object identifying component is configured to generate at least one or a plurality of polygon(s) based on the input, each polygon approximating a part of the input.

22. The system according to claim 21 wherein the system is configured to project the polygon(s) on at least one of the at least one input and the image data.

23. The system according to claim 22 wherein the object identifying component is configured to process elevation coordinates of the vertexes of the at least some polygon(s) projected to the input and/or image data.

24. The system according to claim 21 wherein the analysing component is configured to generate a reference surface for each of at least some of the polygons.

25. The system according to claim 24 wherein the analysing component is configured for determining a volume between a portion of the input and a portion of the reference surface for each reference surface.

26. The system according to claim 23 wherein the analysing component is configured to modify the at least one elevation coordinate of the vertexes of the at least some polygons, wherein modify comprises modifying the at least one elevation coordinate corresponding to the image object based on the reference surface.

27. The system according to claim 25 wherein a portion of the reference surface is a portion of the reference surface within the corresponding polygon and the portion of the input is a portion of the input within said polygon.

28. The system according to claim 16 wherein the class corresponds to a part of the input, further wherein the class comprises at least a portion of the object.

29. The system according to claim 16 wherein the analysing component is configured to assign portions of the input comprising same class to a group, wherein the analysing component is further configured to modify the at least a portion of the group from the processed input.

30. The system according to claim 16 wherein the object identifying component is configured to generate the class of the object using the image data and wherein the analysing component is configured to identify the at least one object from the image data based on the class.

31. A method, comprising:
processing at least one input by a data processing component to generate image data,
automatically generating at least one class using the object identifying component,
automatically modifying at least one portion of the image data based on the class.

32. A computer program product comprising instructions which, when the program is executed by a computer, cause the computer to:
process at least one input by a data processing component to generate image data,
automatically generate at least one class using the object identifying component,
automatically modify at least one portion of the image data based on the class.
